(19) United States
(12) Patent Application Publication
(10) Pub. No.: US 2024/0156221 A1
(43) Pub. Date: May 16, 2024

(54) Cleaning Device for Contacting Surfaces of Sports Equipment

(71) Applicant: Sean David Tilley, Castle Rock, CO (US)

(72) Inventors: Sean David Tilley, Castle Rock, CO (US); Bruce Leonard Tilley, Thornton, CO (US)

(21) Appl. No.: 18/506,532

(22) Filed: Nov. 10, 2023

Related U.S. Application Data
(60) Provisional application No. 63/383,321, filed on Nov. 11, 2022.

(51) Int. Cl. A45B 3/00; A46B 5/00; A46B 9/02; A63C 11/18; B08B 1/00

(52) U.S. Cl. CPC A45B 3/00; A46B 5/0095; A46B 9/025; A46B 9/026; A63C 11/18; B08B 1/005; A45B 2200/05; A46B 2200/306

(57) ABSTRACT

A sports equipment surface cleaning safety device is disclosed which serves the purpose of removal of materials, such as snow, ice or mud, from boot soles or other contacting surfaces of sports equipment through motions such as scraping or brushing. The device is intended to be integrated within, or mechanically mounted to a pole, such as a ski pole or trekking pole. It is constructed with materials such as plastics and/or metal, utilizing conventional methods of fabrication such as 3d printing, injection molding, gluing, casting, or machining.

### FIELD OF THE INVENTION

The present invention relates to the removal of materials, such as snow, ice or mud, from boot soles or other contacting surfaces of sports equipment to promote safe and optimal operation.

### BACKGROUND OF THE INVENTION

A variety of outdoor sports equipment which interface with footwear rely upon low tolerances to enable the proper and secure mechanical coupling of components to safely perform within the intended operational envelope. The safe and intended performance of outdoor sports equipment can be impacted by the accumulation of snow, ice, mud, or other unwanted materials upon interfacing components such as the tread of a boot sole and equipment such as ski bindings and snowshoes. Additionally, the presence of unwanted materials may also mask damage or defects such as cracks fractures in plastic or metal components. While operational impacts will vary with aspects such as the user, terrain, ambient weather conditions and manner of which the outdoor sports equipment is used; results can include reduced traction, slipping, increased weight of equipment worn or carried, and improper function of mechanical components. Occurrences such as these can lead to injuries associated with fatigue, slips and falls.

While other devices have been proposed as a possible solution, most exhibit shortcomings such as complex installation, potential harm to its users during installation and/or use, potential damage to associated equipment through methods of installation & operation, ergonomically awkward use or storage, or neglect the use-case demands to achieve longevity of product life. Despite the merits of these devices, few, if any, are in use today. Instead, numerous inefficient methods are typically used for self-removal of aforementioned unwanted materials including kicking nearby land features (trees, rocks, etc.), scraping with hands, or utilizing sticks or other pointed objects to remove unwanted materials from sports equipment. While these methods can be effective, sourcing of such rudimentary methods is not always feasible and damage to components leading to injury can occur.

### BRIEF SUMMARY OF THE INVENTION

The present invention comprises a novel multimodal material-removing device which generally provides a solution to break-apart, dislodge, scrape, pull, pry, push or brush-off unwanted solid and semi-solid materials from surfaces such as footwear and sports equipment. The device is intended to be integrated onto, or within, or mechanically mounted to a pole or shaft, such as a ski pole or trekking pole.

The present invention is generally formed from a wide range of plastics and/or metals with characteristics suitable for the outdoor environment such as low temperatures and resistance to impact, axial and torsional forces associated with the intended use of the device. Embodiments of the present invention include two rigid, solid, thin walled, tubular halves with surface cleaning features formed in the outer surface of each component. Tubular halves are then mounted to a pole, by placing the pole within the inside of each tubular half and mechanically clamping each tubular half together with fasteners such as screws or bolts. In another embodiment, the surface cleaning features are embedded within the surface of the pole itself.

### BRIEF DESCRIPTION OF DRAWINGS

Some embodiments of the present invention are demonstrated within the illustrations as an example and are not limited by the accompanying drawings, in which like references may indicate similar references and in which:

FIG. 1. demonstrates a method of use by a skier according to various embodiments as described herein and location of placement on a ski pole.

FIG. 2 demonstrates a method of physical placement on a ski pole according to various embodiments as described herein.

FIG. 3 provides a top-view of the present invention, showing both tubular halves with interlocking channels secured with fasteners according to various embodiments as described herein.

FIG. 4 shows an isometric view of the physical structure, a CAD model of the present invention, providing a clear view of the two rows of symmetrically spaced pyramidal features protruding perpendicularly from the outside surface, spanning the complete latitudinal plane of the second tubular half according to various embodiments of the present invention.

FIG. 5 shows an isometric view of the present invention specifically the tubular half which provides two rows of straight blade-like edges which run parallel to the latitudinal plane of the tubular half and formed from two wedge-like features protruding from the outer surface of the tubular wall according to various embodiments of the present invention.

FIG. 6 shows an isometric view of the physical structure, specifically the tubular half which provides two rows of straight brushes which run parallel to the latitudinal plane of the tubular half according to various embodiments as described herein.

### DETAILED DESCRIPTION OF THE INVENTION

A new cleaning device for sports equipment surfaces and methods for removing foreign material, and construction of the device are discussed herein. In the following description, for the purposes of explanation, numerous specific details are set forth in order to provide a thorough understanding of the present invention. It will be evident, however, to one skilled in the art that the present invention may be practiced without these specific details.

The terminology used herein is for the purpose of describing particular embodiments only and is not intending to be limiting of the present invention. As used herein, terms such as “and/or” include any and all combinations of one or more of the associated listed items. As used herein, the singular forms of “a”, “an”, and “the” are intended to include the plural forms as well as the singular forms, unless the context clearly indicates otherwise. It will be further understood that the terms “comprises, and/or “comprised”, when used in this specification, specify the presence of stated features, step, operations, elements and/or components, but do not preclude the presence or addition of one or more other features, steps, operation, elements, components, and/or groups thereof. Additionally, reference in the specification to “one embodiment” or “an embodiment” or “another embodiment” is indicative that a particular feature, structure, or characteristic described in conjunction with the embodiment can be included in at least one embodiment of the present invention. The appearances of the phrase “in one embodiment” in various places in the specification do not necessarily all refer to the same embodiment.

Unless otherwise defined, all terms used herein have the same meaning as commonly understood by one having ordinary skill in the art to which the present invention belongs. It will be further understood that terms, such as those defined in commonly used dictionaries, should be interpreted as having meaning that is consistent with their meaning in the context of the relevant art and the present disclosure and will not be interpreted in an idealized or overly formal sense unless expressly so defined herein.

In describing the present invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the present invention and the claims.

Various embodiments and aspects of the present invention will be described with reference to details discussed below, and the accompanying drawings will illustrate the various embodiments. The following description and drawings are illustrative of the present invention and are not to be construed as limiting the present invention. Numerous specific details are described to provide a thorough understanding of various embodiments of the present invention. However, in certain instances, well-known or conventional details are not described in order to provide a concise discussion of embodiments of the present invention.

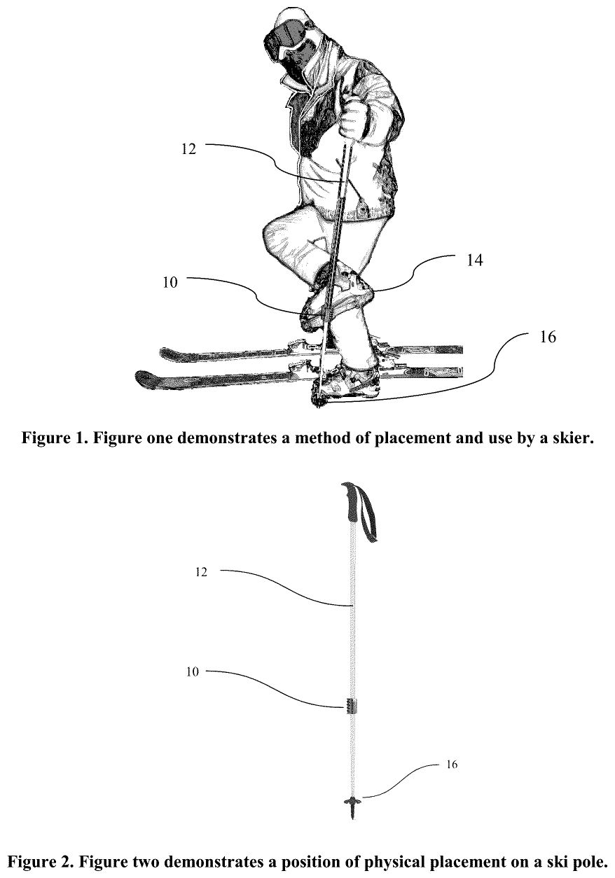

The present invention will now be described by referencing the appended figures representing preferred embodiments. FIG. 1 depicts one embodiment of the present invention designated 10, mounted upon a ski pole 12 and utilized by a skier to remove unwanted materials from the sole of a ski boot 14. Unwanted materials can be removed via strikes, blows, scrapes, prying, pushing, pulling, brushing and/or sweeping in linear and/or circular motion of the present invention with boot soles or other contacting surfaces. FIGS. 1 and 2 also illustrate one embodiment of placement of the present invention, located approximately knee height near the basketed end 16 of the ski pole 12. However, the position of the present invention on a pole and the methods and/or motions used to remove materials will vary from user to user.

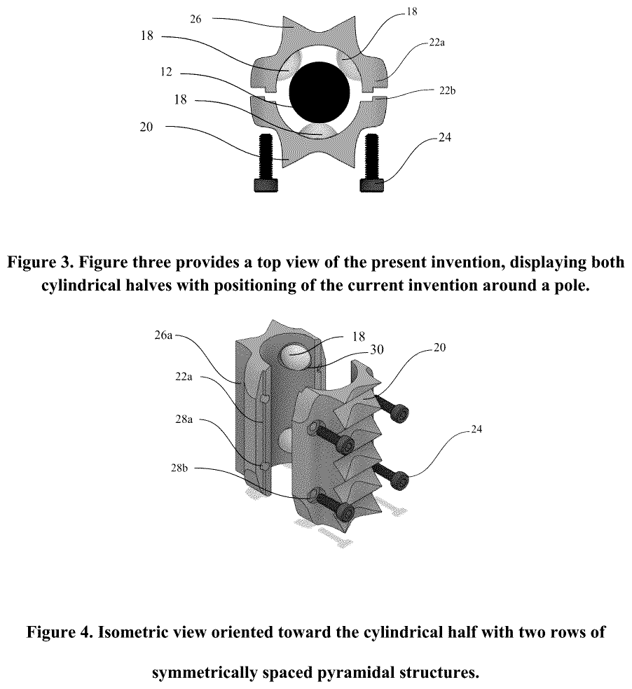

FIG. 3 illustrates one embodiment of the present invention attachment to a pole 12 which is achieved through methods of mechanical clamping around the outside surface of a pole 12 by mating two tubular halves 20 and 26a or 26b via interlocking channels 22a and 22b which are formed from symmetrical protrusions extending from the cross-sectional surface between each side of each tubular half for the full height of each tubular half. Mechanical clamping of each tubular half is achieved via fasteners 24 on either side of each tubular half 20 and 26a and 26b, forming the completed tubular assembly 10. The two interlocking tubular halves are intended to mate with the inner surfaces of each half contacting the outer surface of a pole or shaft. In one embodiment the fasteners illustrated in FIGS. 3, 4, 5 and 6 are to be used in mounting either side 20, 26a and/or 26b are bolts, screws or other fastener achieving similar function. Also illustrated in FIGS. 3, 4, 5 and 6, the small flexible pads 18 are placed within same-shaped extrusion cuts 30 within the inner surface of each tubular half. Each of the extrusion cuts are extend into the inner surface of each tubular half to provide a secure mounting surface for each flexible pad. FIGS. 3, 4, 5 and 6 also illustrate a complimentary arrangement of the small flexible pads on the inner surface of each tubular half to securely constrain a pole 12 placed within the center of the assembly 10. It is a feature of the present invention for the flexible pads to allow the present invention to be mounted to a variety of pole diameters by adding and/or removing flexible pads to enable a secure pole fit that resists torsional and axial forces applied during use.

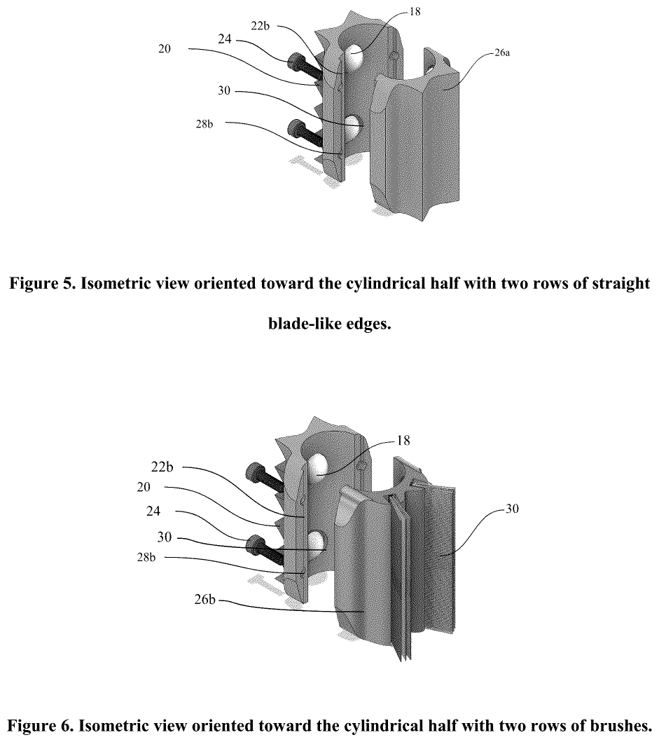

In one embodiment of the device, FIGS. 4, 5 and 6 show each of the two tubular halves 20, 26a and 26b and illustrate the principal material removal device features of the present invention. FIG. 5 illustrates one tubular half 26a providing two rows of straight flat blade-like edges which run for the full height of the device, parallel to the latitudinal plane of the tubular half (also parallel to the pole), formed from two wedge-like features and protrude from the outer surface of the tubular wall. An additional alternate embodiment the present invention is shown in FIG. 6 which illustrates brushes 30 within the tubular half 26b. For the embodiment variation which includes brushes 30, linear brushes are positioned in-place of the aforementioned straight flat blade-like features, and protrude outward from the outer surface of the tubular half 26b. Embodiments of the brushes to be placed onto the outer surface tubular half of 26b include either linear, metal-backing strip brushes that are pressed into channels formed upon the outside surface of the tubular half 26b, or brushes comprised of bristles stapled-set into the outside surface of 26b. The materials for the brushes include materials, such as nylon, with characteristics such as ultraviolet light, cold and/or hot weather, anti-rust and corrosion resistance. It is the object of both the brushes 30 within tubular half 26b and the flat-bladed features of 26a to provide a solution to scrape, push, pull or generally enable the removal of materials from a surface. It is also the object for the tubular halves 26a and 26b to be interchangeable with tubular half 20 based on anticipated outdoor weather conditions.

FIG. 4 illustrates one embodiment of the other tubular half 20. The object of the tubular half 20 is to provide more aggressively formed features to break-up, dislodge, push, pull, scrape and generally enable larger materials firmly secured or lodged within the surface to be removed and/or loosened. One embodiment of these features is the formation of at least one row of symmetrically-spaced pyramidal features protruding perpendicularly from the outside surface, spanning the complete latitudinal plane of the second tubular half 20. It is the overall object of the device that both sides of the tubular assembly are able to be used. However, either side may be used independently of another. A user of the device may initially use the side with the pyramidal features to initially break up or dislodge materials, then once larger or firmly adhered materials are removed or loosened, that the pole is then manually rotated to allow exposure to the other tubular half with the flat bladed 26a, or brush 26b, to finish with surface cleaning as-needed.

The present invention, in any embodiment, can be fabricated with a wide variety of materials and processes. Generally, materials selected should meet technical use-case requirements such as resistance to ultraviolet rays, rust, and corrosion. The materials should also have a high impact & tensile strength, low density, and resist becoming brittle at low temperatures. Numerous materials such as nylon, carbon fiber, polycarbonate and aluminum fulfill these broad requirements. Fabrication of the present invention can be achieved through a variety of methods such as 3d printing, casting, machining, or injection molding.

An alternative embodiment of the present invention is achieved by integration of the surface cleaning features within the outer surface of a pole. Similar to the embodiment of two tubular halves mechanically secured to a pole, an alternate embodiment can be constructed through methods such as casting, gluing, taping, printing, or other methods of adhering the surface cleaning features onto the outer surface of a pole. Material specifications for such an embodiment would be the same as those described for the principal embodiment. Placement, size and configuration is similar to the embodiment shown in FIG. 2.

The invention claimed is:

1. A cleaning device for footwear and sports equipment surfaces comprising:
A rigid tubular body with a height substantially greater than its inner and outer radius; bisected along its length with a plurality of surfaces upon each tubular half including outside faces spanning length and outside radius of each tubular half, inside faces spanning the length and inside radius opposite of the outside face, other inside faces upon the cross-sectional area spanning the length and thickness of the walls of each tubular half, a top face at the top of each tubular half, and a bottom face opposite each top face; outside faces of each specified tubular half are formed with curves and a plurality of outwardly projecting edges; tubular halves are firmly secured to the outside surface of a pole or shaft by methods of mechanical clamping each tubular half around a pole or shaft.

2. The cleaning device of claim 1, wherein a mechanical clamping system of each tubular half is achieved by methods of using fasteners on each outside surface of each tubular half thereby connecting each half and includes interlocking channels to further secure each half to another; where upon the specified cross-sectional areas of inside faces on each tubular half are referenced interlocking channels formed from symmetrical protrusions running the full length and half the width of each cross-sectional area of each tubular half.

3. The cleaning device of claims 1 and 2, wherein mechanical clamping is achieved by a plurality of fasteners, such as bolts, which are placed into through-holes formed, or drilled, perpendicularly to the length of the tubular half, through the outside walls of each tubular half; connecting another tubular half by use of threaded nuts placed within the wall of the tubular half in same plane as the through-hole.

4. The cleaning device of claim 1, wherein tubular halves are removable from a pole or shaft without damaging surface of a pole or shaft.

5. The cleaning device of claim 1, wherein a universal fit of the cleaning device to ski poles or trekking poles or similar diameter poles is achieved by the addition or removal of soft flexible pads secured within same-shape extrusion cuts spaced symmetrically and placed radially along the latitudinal plane of the concave area within each inside face of each tubular half to securely constrain a pole within the center bore of the cleaning device.

6. The cleaning device of claim 1, wherein the mechanical clamping system permits positioning of the cleaning device at any point along the length of a pole.

7. The cleaning device of claim 1, wherein the color of the cleaning device includes all primary, secondary and tertiary color variations including red, orange, yellow, green, blue, violet, purple and any combination thereof.

8. The cleaning device of claim 1, wherein the surface finish of the cleaning device includes all variations of matte, satin, flat, reflective, glow-in-the-dark, electronically illuminated, metallic and texture variations including smooth, rough, and coarse.

9. The cleaning device of claim 1, wherein a tubular half has a plurality of blade-like edges, formed from wedge-like shapes, protruding outwardly from the outside face which span the full length of the cleaning device.

10. The cleaning device of claim 1, wherein a tubular half has a plurality of coarse brushes placed within channels, or staple-set within the outside face of the tubular half, spanning the full length of the cleaning device and protrude outwardly from the outside face of the cleaning device.

11. The cleaning device of claim 1, wherein a tubular half has a plurality of symmetrically spaced pyramidal features protruding outwardly perpendicularly from the outside face spanning the full length of the tubular half.

12. The cleaning device of claim 1, wherein tubular halves are interchangeable for mounting to a pole.

13. A cleaning device for footwear and sports equipment surfaces comprising:
A cleaning device embedded within the outside surface of a pole, such as a ski pole or trekking pole.

14. The cleaning device of claim 13, wherein a plurality of blade-like edges are formed from wedge-like shapes, protruding outwardly from the outside face of a pole spanning the full or half circumference of a pole, and a length of 1 to 6 inches along the length of a pole positioned near the bottom end of referenced pole.

15. The cleaning device of claim 13, wherein a plurality of coarse brushes placed within channels, or staple-set within the outside face of a pole and protrude outwardly from the outside face of a pole spanning the full or half circumference of the pole, and a length of 1 to 6 inches along the length of a pole positioned near the bottom end of a pole.

16. The cleaning device of claim 13, wherein a plurality of symmetrically spaced pyramidal features protruding outwardly perpendicularly from the outside face spanning the full or half circumference of a pole, and a length of 1 to 6 inches along the length of a pole positioned near the bottom end of the pole.
